(19) United States
(12) Patent Application Publication
(10) Pub. No.: US 2005/0073846 A1
(43) Pub. Date: Apr. 7, 2005

(54) Lightemitting device and method of manufacturing the same

(76) Inventor: Kenji Takine, Anan-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/490,763

(22) PCT Filed: Sep. 27, 2002
(86) PCT No.: PCT/JP02/09996

(30) Foreign Application Priority Data
Sep. 27, 2001 (JP) 2001-297249

(51) Int. Cl. F21V 7/00

(52) U.S. Cl. 362/296; 362/341

(57) ABSTRACT

A light emitting apparatus includes a metallic substrate having at least one recess on the surface and at least one projection opposing the recess on the back surface thereof, a light emitting element mounted in the recess of the metallic substrate, the light emitting element having a pair of positive and negative electrodes formed on one side thereof, and electrically conductive members formed via an insulating member on the surface of the metallic substrate, the electrically conductive members being electrically connected with the pair of positive and negative electrodes of the light emitting element.

### TECHNICAL FIELD

The present invention relates to a light emitting device comprising a semiconductor element mounted on a mounting substrate, and particularly to a light emitting device that provides a light source having high luminance by using a metallic substrate having recess formed therein as the mounting substrate and providing a light reflecting layer on side face of the recess.

### BACKGROUND ART

Fluorescent lamps and incandescent lamps are currently used as ordinary light sources, and they have short life times and high power consumption. LED, when used as a light source, has a longer life time and lower power consumption. Thus LED is viewed as promising for use as a light source that replaces fluorescent lamp and the like.

Problems that arise when LED is used as a light source are heat dissipation of the LED and the efficiency of extracting light. When heat is not dissipated efficiently from the LED apparatus, light output may decrease and/or life time of the LED may become shorter due to the heat applied to the LED.

FIG. 1 is a schematic sectional view showing a light emitting device 10 having an LED mounted in a conventional LED package. Reference numeral 13 denotes a metallic substrate, 14 denotes a resin substrate and 15 denotes an electrically conductive member formed in a pattern on the resin substrate. The resin substrate 14 having through holes formed therein is bonded with the metallic substrate 13 by means of an adhesive or the like. An LED chip 11 is mounted in a recess formed by side face of the through hole in the resin substrate 14 and the surface of the metallic substrate 13. The LED chip 11 is bonded onto the metallic substrate 13 by means of an adhesive or the like, and a pair of positive and negative electrodes formed on the LED chip 11 are electrically connected to the electrically conductive members with electrically conductive wires 16 such as gold wire. The LED chip 11 is hermetically sealed within the recess by means of a sealing member 12.

However, since the resin substrate 14 has a low heat conductivity and provides poor heat dissipation through the side face of the recess, the LED mounting substrate tends to overheat. As a result, the sealing member, the adhesive and the other components deteriorate and the luminance of light emission decreases. Also because the heat makes the bonded portion easier to peel off, life time of the LED apparatus 10 becomes shorter. Such problems become more conspicuous when a plurality of LEDs are mounted for the purpose of increasing the light output, and particularly when a plurality of LEDs are mounted closer to each other, since the total amount of heat generated from the entire LED mounting substrate becomes larger. Although heat dissipation from the LED mounting substrate can be improved by forming a heat sink or the like on the metallic substrate 13, it necessitates extra work of machining the metallic substrate 13.

Also since the resin substrate 14 and the metallic substrate 13 are bonded to fix to each other by means of an adhesive or the like, insufficient amount of the adhesive leads to a gap formed between the metallic substrate 13 and the resin substrate 14, and excessive amount of the adhesive leads to overrunning of the adhesive into a through hole. This results in variations in the volume among the recesses. As a result, uniformity of shape cannot be achieved among the sealing members that fill the recesses when a plurality of LEDs are mounted and sealed with the sealing members in a plurality of recesses. As a consequence, luminance of light emitted from the LEDs varies and the efficiency of extracting light of the entire apparatus decreases.

Furthermore, since the resin substrate 14 located on the side face of the recess is somewhat pervious to light, it is not satisfactory for use as a light reflecting material to increase the efficiency of extracting light. Also because the side face of the recess rises vertically, even a reflected part of the light is not directed to the front of the LED mounting substrate, resulting in further decrease of the efficiency of extracting light.

### DISCLOSURE OF INVENTION

Based on a research on a constitution that would improve the heat dissipation and improve the efficiency of extracting light in order to solve the problems described above, the present inventors have found that an ideal LED mounting substrate can be made by using a metal in most part of the substrate without using a resin substrate, and forming light reflecting layers on the side face and bottom surface of a recess that has a tapered or mortar shape, upon which the present invention was completed.

The light emitting apparatus of the present invention comprises a metallic substrate, a light emitting element that has a pair of positive and negative electrodes formed on one side thereof and is mounted on the metallic substrate, and electrically conductive members that are formed via an insulating member on the surface of the metallic substrate and are electrically connected with the pair of positive and negative electrodes of the light emitting element, wherein the metallic substrate has recess formed on the surface thereof so as to house the light emitting element, and a projection formed on the back surface so as to oppose the recess.

Since the light emitting device of the present invention can be constituted by making most of the mounting substrate from a metal having high heat conductivity, efficiency of heat dissipation from the entire light emitting device is improved. When a recess is formed by pressing a metal plate on the upper surface thereof, a projection is simultaneously formed on the lower surface (mounting surface) opposing the recess formed on the upper surface. As the projection serves as a heat sink, efficiency of heat dissipation from the entire light emitting device is further improved.

In the light emitting device of the present invention, it is preferable that the metallic substrate has a plurality of the recesses and a plurality of the projections, and an LED is mounted in each of the recesses. A light emitting device having such a constitution is suited for a light source used in place of fluorescent lamp and incandescent lamp with increased light output per unit area of the metallic mounting substrate, since high efficiency of heat dissipation can be maintained even when a plurality of LEDs are mounted close to each other on the metallic mounting substrate and operated with a large current flowing therein. Also when the recesses are formed with uniform size and shape, quantity of the sealing member becomes uniform among the recesses that are filled therewith. As a result, even when a plurality of LEDs are mounted, there occurs no variation among the LEDs and the efficiency of extracting light can be improved.

In the light emitting device of the present invention, it is preferable that the inner wall of the recess is formed in the shape of mortar. That is, the side face of the recess is preferably inclined so that vertical sectional area of the recess is a trapezoid with the top side larger than the bottom. This configuration makes it possible to have light emitted sideways from the LED reliably directed forward to the front by the light reflecting layer, so that a larger proportion of light emitted by the LED chip can be utilized as the light source.

Also in the light emitting device of the present invention, since the inner wall of the recess is preferably formed from a metal, light is reflected thereon with higher efficiency than in the case of the conventional resin substrate that has some permeability to light, thus making it possible to have light emitted sideways from the LED reliably directed forward by the light reflecting layer, so that a larger proportion of light emitted by the LED chip can be utilized as the light source. More preferably, a light reflecting layer is formed on the inner wall of the recess, which further improves the efficiency of utilizing the emitted light.

A method of manufacturing the light emitting device of the present invention comprises the steps of applying a pressure on the front surface of a metal plate so that a part of the metal plate protrudes on the back surface (the mounting surface), thereby to form the recess and the projection on the front and back surfaces of the metal plate at the same time; forming an electrically conductive member via the insulating member on the surface of the metal plate near the recess; housing a light emitting element that has pair of positive and negative electrodes formed on the same side thereof in the recess of the metal plate; and electrically connecting the electrically connecting members with the pair of positive and negative electrodes of the light emitting device.

This makes it possible to form the projection on the mounting surface opposing the recess that is formed on the upper surface simultaneously as the metal plate is press-molded. Since the projection serves as a heat sink, heat dissipation of the entire light emitting device can be easily improved without the need of carrying out extra work to form a heat sink.

With the method of manufacturing the light emitting device of the present invention, pressure may be applied to an exposed upper surface of the metal plate so as to form the recess and the projection, after forming the electrically conductive layer via the insulating layer on the upper surface of the metal plate and then exposing a part of the upper surface of the metal plate from the side of the electrically conductive layer.

This method is preferable since it makes it unnecessary to align the through hole formed in the insulating member and the opening of the recess when bonding the metallic mounting substrate and the insulating member via the insulating adhesive.

The method of manufacturing the light emitting device of the present invention may include the step of forming the light reflecting layer on the inner wall of the recess after the step of forming the recess and the projection on the metal plate.

This method enables it to obtain the light emitting device capable of increasing the proportion of light that can be used as a light source to the total light emitted by the LED chip. That is, it is made possible to achieve high efficiency of reflecting light and have light emitted sideways from the LED reliably directed forward by the light reflecting layer, by forming the light reflecting layer.

### BRIEF DESCRIPTION OF DRAWINGS

FIG. 1 is a partially enlarged sectional view schematically showing a conventional light emitting device having LED mounted thereon.

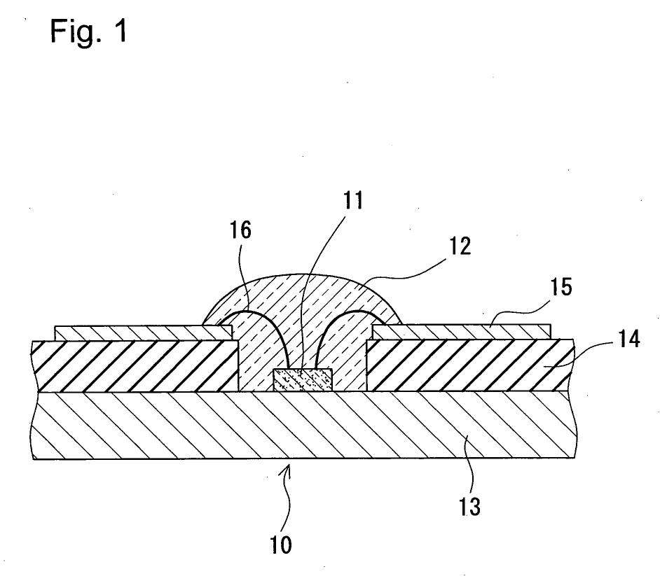

FIG. 2 is a partially enlarged sectional view schematically showing a light emitting device of the present invention having LED mounted thereon.

FIG. 3 is a plan view schematically showing the light emitting device of the present invention having LED mounted thereon.

FIG. 4 is a sectional view taken along lines A-A′ of FIG. 3.

FIG. 5 is a partially enlarged sectional view schematically showing a light emitting device according to another embodiment of the present invention.

### BEST MODE FOR CARRYING OUT THE INVENTION

In a preferred embodiment of the present invention, the metallic mounting substrate is constituted from a metal plate having a recess formed on the upper surface thereof, of which shape is like mortar that is wider toward the mouth, and a projection formed on the lower surface (mounting surface) so as to oppose the recess, and a light reflecting layers formed on the side faces and bottom surface of the recess. The light emitting device that uses the metallic mounting substrate of the present invention comprises an LED chip housed in the recess, an insulating member that insulates the electrically conductive member from the metallic mounting substrate, electrically conductive wire that connects the LED chip and the electrically conductive member, and a sealing member that hermetically seals the LED chip. The metallic mounting substrate having the light emitting device is machined so as to house the LED chip in the recess. The light reflecting layer reflects light, that is emitted by the LED in directions other than the front direction, into the front direction of the light emitting device.

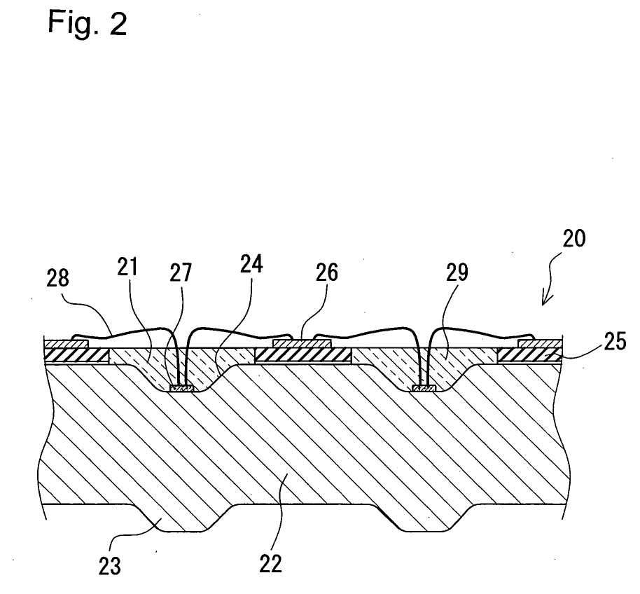

Now components of the present invention will be described below with reference to FIG. 2.

(Recess 21)

The metallic mounting substrate 22 that has the recess having such a shape as becoming wider toward the mouth and the projection formed on the opposite side of the recess may be made of almost any metal such as copper, copper-containing iron, copper-containing tin, aluminum and aluminum alloy. It is preferable that aluminum is press-molded to form the recess, since this results in the inner wall of the recess formed with a surface resembling a mirror while aluminum has high reflectivity over broader wavelength region than other metals. Use of copper is more preferable since copper has higher heat conductivity than other metals including aluminum and aluminum alloy.

The recess may be formed on the upper surface of the metal plate either by (a) press molding which is a kind of press machining process wherein a die is pressed against the workpiece so as to cause local deformation only in the machined portion with the pressure thereby forming a recess of mortar shape or tapered shape, or by (b) metal removing process wherein a drill is applied to the workpiece so as to locally remove the material from the machined portion thereby to reduce the thickness thereof. Since the metal removing process results in roughened surface of the inner wall of the recess and variability in the size of the recess, it is preferable to form the tapered or mortar-shaped recess by press molding using a die.

In the press molding process using a die, for example, the die having convex shape (inverted mortar shape) is pressed at right angles to the surface of a copper plate so as to form a mortar-shape recess with the pressure, then the die is pulled away from the copper surface in a direction perpendicular thereto, thereby forming the mortar-shape recess of the present invention. When a die having a plurality of portions of convex shape (inverted mortar shape) is used in press molding, a plurality of recesses of the same dimensions can be formed on the metal plate in a single operation. When a plurality of recesses of the same dimensions are formed by using a die having a plurality of portions of convex shape (inverted mortar shape) in the press molding operation, every thing from the recesses to the mounting surface are formed on the same metal plate and the plurality of recesses having the same shape and dimensions are formed, so that all recesses can be filled with the same quantity of the sealing member. As a result, even when a plurality of LEDs are mounted, such favorable effects can be achieved as there is less variation in the luminance of light emission among the LEDs and improved efficiency of extracting light. Also because satisfactory heat dissipation can be maintained even when the plurality of LEDs are mounted closer to each other on the metallic mounting substrate and are operated with a large current, with increased light output per unit area of the metallic mounting substrate, this constitution is suited for a light source used in place of fluorescent lamp and incandescent lamp.

Use of the press molding also makes it possible to easily change the depth of the recess by changing the pressure of pressing the recess having protruding shape against the copper plate. In order to improve the efficiency of extracting light by using the light reflecting layer formed on the side face of the recess as a reflector, minimum required depth of the recess is the same as the height of the active layer of the LED chip. When the recess is too deep, light emitted by the LED may undergo random reflection in the recess thus making the color tone of the light emitted by the LED different from the desired one. Bottom of the recess is formed to have larger area than the bottom surface of the LED chip so as to facilitate mounting of the LED chip. Height of the electrically conductive member from the electrode surface of the LED that is mounted is set in accordance to the optical characteristic of the LED, and such that connection can be established by using electrically conductive wire or wire bonder.

The larger the distance from the bottom of the recess to the mounting surface (back surface of the metal plate), the larger the calorific value when the metal plate is saturated by the heat generated by the LED. Heat generated by the LED can be efficiently dissipated till the metal plate is saturated by the heat generated by the LED mounted thereon.

(Protrusion 23)

When the metal plate is press-molded with the die, the projection is simultaneously formed, by the metal protruded by pressing, on the mounting surface on the opposite side of the surface of the metal plate where the die makes contact with (upper surface on which the recess is formed). Single constitution of the same metal plate from the recess to the projection on the mounting surface, and function of the projection formed on the mounting surface as a heat sink result in improved efficiency of heat dissipation from the entire mounting substrate. As a result, the light emitting device of the present invention has satisfactory heat dissipation even when the plurality of LEDs are mounted close to each other on the metallic mounting substrate and are operated with a large current. Therefore, the light emitting device of the present invention has increased light output per unit area of the metallic mounting substrate, and is suited for a light source used in place of fluorescent lamp and incandescent lamp.

When the press molding is carried out by placing the metal plate on a flat work bench without recess and pressing the die onto the upper surface of the metal plate, the projection cannot be formed on the mounting surface. Therefore, it is preferable to fix the metal plate on work bench having recess or groove, so that the projection, which makes a heat sink, is formed on the mounting surface at the same time as the recess is formed with the projection. Depth and width of the recess or the groove are made similar to the depth and width of the recess. This causes the projection to function as the heat sink and increases the surface area of the copper plate on the mounting surface side, thereby improving the efficiency of heat dissipation.

(Light Reflection Layer 24)

It is preferable to form the light reflection layer 24 on the side face and the bottom surface of the recess. While almost any metal can be used for the light reflection layer 24, silver or aluminum is preferably used. Silver and aluminum have better characteristics than gold and the like in terms of favorable metallic white color, no absorption of the incident light and reflection characteristic that does not change the color of the reflected light. In case copper is used as the material of the metallic mounting substrate, silver has poor affinity with copper. Therefore, it is preferable to use nickel that has affinity with copper and silver. After a nickel layer is formed on copper, a silver layer may be formed thereon.

While the light reflecting layer may be formed by such methods as electroplating, electroless plating, vapor deposition or sputtering, electroplating is preferably employed. By using electroplating method, the metal layer according to the present invention can formed easily. In comparison to electroless plating and other, electroplating allows it to easily control the thickness of the plating layer and reduce the manufacturing cost. According to the present invention, electroplating process can be carried out, for example, as follows. After forming a plurality of recesses in a copper plate, portions other than the recesses are masked by photolithography and the copper plate is immersed in molten nickel so as to form nickel plating layer on the surface of the recess. Then the copper plate is immersed in molten silver so as to form silver plating layer on the nickel layer, and the mask is removed.

(Insulating Member 25)

According to the present invention, an insulating member 25 that has a plurality of through holes having substantially the same diameter as the opening of the recess is bonded onto the copper plate using an insulating adhesive so that the through holes are aligned with the openings of the recesses. Bonding between the insulating member 25 and the copper plate can be carried out by using an insulating adhesive made of a thermosetting resin or the like. Specifically, epoxy resin, acrylic resin or imide resin may be used. The insulating member is made of an insulating resin that is epoxy resin, urea resin, silicone resin or the like that is hardened. Thickness of the insulating member is preferably sufficiently small in comparison to the metal plate as long as the metal plate and the electrically conductive member are electrically insulated from each other. Making the insulating member thinner makes it possible to use a metal of high heat conductivity in most part of the mounting substrate, and improve the heat dissipation of the entire light emitting device.

(Electrically Conductive Member 26)

The electrically conductive member 26 is formed in a predetermined pattern to form wiring on the upper surface of the insulating member with a conductor. The electrically conductive member 26 is used for electrically connecting the electrodes of the LED chip mounted in the recess with the outside of the package. While the electrically conductive member may be provided after attaching the insulating member onto the metallic mounting substrate 22, such process may also be employed as the insulating member having the electrically conductive member attached on the upper surface thereof is prepared in advance and then attaching it onto the metallic mounting substrate 22. The electrically conductive member may be formed by coating the upper surface of the insulating member with an electrically conductive paste by screen printing. Or, alternatively, the electrically conductive member may also be formed by photolithography. The electrically conductive paste may be a good electric conductor such as copper, nickel or phosphor bronze.

(LED Chip 27)

The LED chip used in the present invention may be constituted from, for example, nitride compound semiconductor. The LED that is a light emitting element is made by forming a semiconductor layer such as InGaN as a light emitting layer on a substrate by MOCVD process or the like. The semiconductor may have homo-junction that has MIS junction, PIN junction or pn junction, hetero-junction structure or double hetero-junction structure. Wavelength of emitted light can be set by selecting the material of the semiconductor layer and the composition of mixed crystal. Single quantum well structure or multiple quantum well structure may also be employed by forming the semiconductor active layer in a thin film that enables quantum effect.

When gallium nitride compound semiconductor is used, the semiconductor substrate may be made of sapphire, spinel, SiC, Si, ZnO or the like. It is preferable to use sapphire substrate in order to form gallium nitride of good crystallinity. A buffer layer of GaN, AlN or the like is formed on the sapphire substrate, and gallium nitride semiconductor having pn junction is formed thereon. The gallium nitride semiconductor shows n-type conductivity when it is not doped with an impurity. When an n-type gallium nitride compound semiconductor having high efficiency of light emission is to be formed, it is preferable to introduce Si, Ge, Se, Te, C or other impurity as n-type dopant. When a p-type gallium nitride semiconductor is to be formed, Zn, Mg, Be, Ca, Sr, Ba or the like is added as p-type dopant.

Since the gallium nitride compound semiconductor cannot be easily turned to p-type simply by doping a p-type dopant, it is preferable to decrease the resistance by heating in a furnace, irradiating with low-velocity electron beam or irradiating with plasma. After forming an exposed surface of the p-type semiconductor and the n-type semiconductor by etching or the like, electrodes having desired shapes are formed on the semiconductor layer by sputtering, vacuum vapor deposition or other process.

Then the semiconductor wafer is divided into chips by completely cutting off the wafer with a dicing saw that rotates a blade having diamond tips (full cut), or cutting grooves wider than the blade width (half cut) and then cleaving the semiconductor wafer by applying an external force. Alternatively, the semiconductor wafer may also be divided into chips by applying an external force after scribing checkered pattern by means of a scriber having a diamond tip that makes reciprocal straight motion. Thus the LED chip constituted from gallium nitride compound semiconductor can be made.

The LED chip is placed in the recess, and is fastened onto the bottom of the recess with an insulating adhesive. Bonding between the LED chip and the bottom of the recess may be done using a thermosetting resin or the like. Specifically, epoxy resin, acrylic resin or imide resin may be used. The joint between the LED chip and the bottom of the recess is a place where light and ultraviolet ray are particularly concentrated in the recess. This is because light and ultraviolet ray emitted by the LED chip are reflected by the resin of the sealing member and fluorescent material contained therein. As a result, the resin located in the joint is considered to be prone to deterioration and, when it is undergoes deterioration such as yellowing, efficiency of light emission may decrease. Therefore, in order to prevent deterioration due to ultraviolet ray or reduce the absorption of ultraviolet ray, it is preferable to use glass or a resin containing ultraviolet ray absorbing agent as the adhesive.

(Electrically Conductive Wire 28)

After placing the LED chip in the recess, positive and negative electrodes and the electrically conductive members are connected by wire bonding. The electrically conductive wire is desired in order to provide good ohmic characteristic with the electrodes of the LED chip, mechanical connectivity, electrical conductivity and heat conductivity. Heat conductivity is preferably 0.01 cal/cm²/cm/° C. or higher, and more preferably 0.5 cal/cm²/cm/° C. or higher. In consideration of workability, diameter of the electrically conductive wire is nor less than 10 μm and not larger than 45 μm. The electrically conductive wire may be made of a metal such as gold, copper, platinum or aluminum, and an alloy thereof.

(Sealing Member 29)

The sealing member 29 that fills the recess is provided for the purpose of protecting the LED chip and the electrically conductive wire from the environment in accordance to the object of the light emitting diode. The sealing member may be formed by using various resins and glass.

The sealing member can be preferably made of a transparent resin having good weatherability such as epoxy resin, urea resin, silicone resin or glass. Directivity of light emission from the LED can be mitigated to increase the view angle, by adding a dispersing agent in the sealing member. For the dispersing agent, barium titanate, titanium oxide, aluminum oxide, silicon oxide or the like can be preferably used.

Since the spaces to be filled with the sealing member have the same shape and size, the recesses are filled with the same quantity of the sealing member so that there are no variability among the LEDs when a plurality of LEDs are mounted, thus preventing the efficiency of extracting light from the light emitting device as a whole from decreasing. The sealing member may also contain fluorescent material such as YAG (yttrium-aluminum-garnet), so that the fluorescent material absorbs a part of light emitted by the LED and emits light of longer wavelengths than those of the absorbed light. When the light emitting diode of the present invention is constituted so as to emit white light by mixing fluorescent materials in the sealing member, main emission wavelength of the light emitting element is preferably in a range from 400 nm to 530 nm in consideration of the complementary color relationship with the fluorescent material, and more preferably in a range from 420 nm to 490 nm. In order to improve the efficiencies of light emission of the LED and the fluorescent material, the wavelength is more preferably in a range from 450 nm to 475 nm.

Now examples of the present invention will be described in detail below. It is understood, however, that the present invention is not limited by the following examples.

### EXAMPLE 1

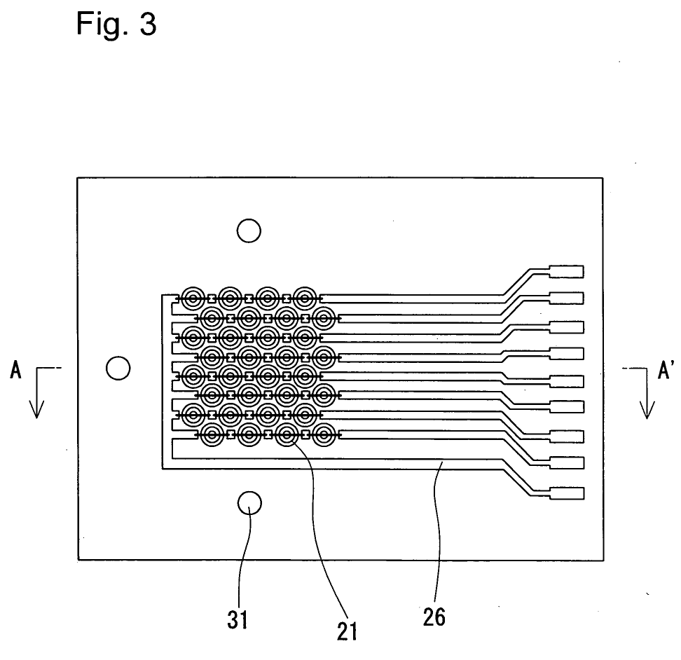

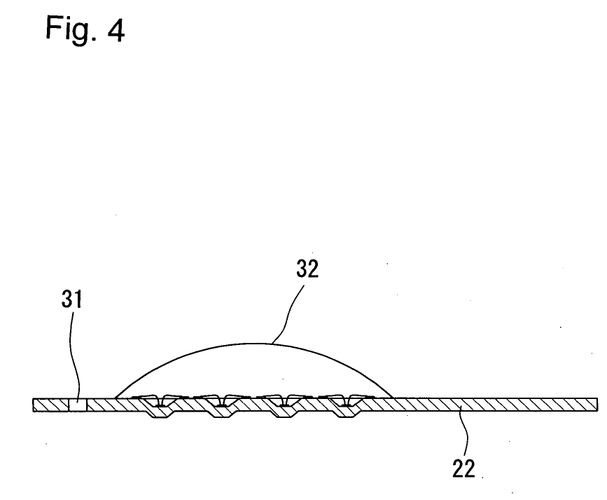

FIG. 3 is a plan view schematically showing a LED mounting substrate for light source of the present invention having LED mounted thereon in one example. FIG. 4 is a sectional view taken along lines A-A′ of FIG. 3. The LED mounting substrate for light source of the present invention is made in such a configuration as the recess formed in the metallic mounting substrate 22 becomes wider toward the opening as shown in FIG. 2, where the light reflecting layer 24 consists of metal layers formed on the side face of the recess and on the bottom surface, and the electrically conductive member 26 is provided via the insulating member 25. When the LED mounting substrate for light source of the present invention is used as shown in FIG. 3, it is preferable to form a plurality of recesses 21 on the same plane and place a plurality of LEDs therein. The mounting substrate having the plurality of LEDs mounted thereon makes it possible to obtain a level of brightness comparable to that of the conventional fluorescent lamp and incandescent lamp, and can be used as a light source in place of the fluorescent lamp and incandescent lamp.

While the metallic mounting substrate 22 may be made of almost any metal, copper plate is used in this embodiment. Copper is suited for the metal plate used for making the LED mounting substrate for light source because of high heat conductivity, good machinability, low cost and easy availability. A protruding die is placed on the upper surface of the copper plate and the metallic mounting substrate 22 measuring 50 mm in length, 35 mm in width and 2.0 mm in thickness having the mortar-shaped recesses as shown in FIG. 3 and FIG. 4 is made. Depth of the mortar-shaped recess is set at 0.4 mm and angle of inclination of the side face of the recess is set at 45 degrees with respect to the bottom surface of the recess. Forming the recess in such shape enables it to improve heat dissipation from the bottom of the LED chip and the side face of the recess to the substrate while maintaining mechanical strength of the mounting substrate, and have the light, which is emitted sideways from the LED, reflected and directed forward in front of the light emitting device. By using the same die to form a plurality of mortar-shaped recesses at the same time on the same copper plate, a plurality of mortar-shaped recesses of the same shape and dimensions can be formed on the copper plate. Since these recesses are formed so as to be flared toward the mouth, it is favorably shaped to reflect the light, which is emitted sideways from the LED, reflected and directed forward in front of the light emitting device and improve the efficiency of extracting light. When the metal plate is press-molded on the front surface, the projection 23 is formed, by the metal protruded by pressing, on the component mounting surface on the opposite side of the surface of the metal plate where the die makes contact with. When depth of the recess is 0.4 mm, height of the projection 23 is about 0.2 mm. As the plurality of projections 23 are formed on the mounting surface on the opposite side of the surface of the metal plate where the die makes contact with, the projections function as heat sink and improve the efficiency of heat dissipation from the metallic mounting substrate as a whole. The metallic mounting substrate 22 has a plurality of through holes 31 formed therein for fastening the light emitting device. The light emitting device can be fastened at a desired position by passing screws or other fastening members through the though hoes 31.

The light reflecting layer 24 is preferably formed from two metal layers. In this embodiment, the light reflecting layer 24 is formed from nickel that has good affinity with copper and silver that has good affinity with nickel. First, after masking the portions of the metal plate other than the recesses, the copper plate was immersed in molten nickel to form a nickel layer having thickness of 3 to 7 μm. Since nickel has lower heat conductivity than copper, it becomes difficult to dissipate heat from the nickel layer to the copper plate when the nickel layer is too thick. Therefore, the nickel layer is as thin as possible in order to improve heat dissipation. Then the copper plate plated with nickel was immersed in molten silver to form a silver layer having thickness of 3 to 7 μm. Last, the mask that covers the portions of the metal plate other than the recesses is removed. Thus the inner wall surface of the recess is plated with silver so that light emitted by the LED sideways can be reflected and reliably directed forward in front of the light emitting device.

The insulating member 25 that insulates between the metallic mounting substrate 22 and the electrically conductive member 26 is made by making a plurality of through holes in a thin plate made of an insulating resin. The through holes have substantially the same diameter as the opening of the recess. Thickness of the insulating member 25 is small in comparison to the metal plate as long as the metal plate and the electrically conductive member are electrically insulated from each other, and is 0.1 mm while the metal plate thickness of 2.0 mm. Thus the metal having good heat conductivity is used on most part of the mounting substrate, and heat dissipation of the light emitting device as a whole can be improved.

Provided on the upper surface of the insulating member 25 is wiring made from a metal, for example copper, so as to form the electrically conductive member 26. The electrically conductive member 26 is formed by coating the upper surface of the insulating member 25 with copper paste by screen printing. The metallic mounting substrate 22 and the insulating member 25 are bonded with an insulating adhesive or the like while aligning the through hole and the opening of the mortar-like recess.

After the electrodes of the LED and the electrically conductive members are connected by wire bonding, the plurality of recesses are filled with specified quantities of epoxy resin as the sealing member, thereby hermetically sealing the LEDs. The epoxy resin may contain a fluorescent material that absorbs the light emitted by the LED and emits light of different color. Since the portions that are filled with epoxy resin have the same shape and size, the quantity of epoxy resin that fills the recesses and the amount of fluorescent material contained therein are the same among the recesses, and therefore there occurs no variability in the luminance of light emission among the LEDs and the efficiency of extracting light from the light emitting device as a whole can be prevented from decreasing. Epoxy resin may be applied so that the surface of epoxy resin becomes parallel to the upper surface of the copper plate as shown in FIG. 2, or so that epoxy resin has dome shape that covers the entire electrically conductive wires as shown in FIG. 3 and FIG. 4. It is preferable to apply epoxy resin in dome shape since it causes the epoxy resin to protect the electrically conductive wire as a whole from external impact so as to elongate the life time of the light emitting device and provide a stable light source having constant directivity.

### EXAMPLE 2

While one LED was placed in one recess in Example 1, a plurality of LEDs may also be placed in one recess. For example, LEDs that emit three primary colors, blue (B), green (G) and red (R) may be placed in a recess. In such a constitution, light emitted by the LED chip is reflected on the inner surface of the light reflecting layer and is directed forward in front of the light emitting device, thereby improving the luminance of light emission and sufficiently mixing the light emitted by the LEDs within the recess.

### EXAMPLE 3

In Example 1 and Example 2, the insulating member having the through holes is bonded onto the metal plate with the insulating adhesive and the electrically conductive members are provided on the insulating member, after forming the recess on the upper surface of the metal plate and the projection on the component mounting surface and forming the light reflecting layer. However, the metallic mounting substrate may also be made by preparing a substrate whereon an insulating layer is formed on the upper surface of an ordinary metallic substrate, namely a metal plate, and an electrically conductive layer is formed on the insulating layer. The ordinary metallic substrate is formed, for example, by bonding the insulating layer and the electrically conductive layer on the metal plate with an insulating adhesive. The metal plate, the insulating member and the electrically conductive member are made of the same materials as those of the metal plate, the insulating member and the electrically conductive member of Example 1, respectively. When such a substrate is used, the insulating member and the electrically conductive member on the upper surface side of the metal plate at the positions where the recesses are formed are removed by machining from the electrically conductive member side to such a depth as the upper surface of the metal plate is exposed. A wiring pattern similar to that of the electrically conductive member 26 shown in FIG. 3 is formed on the remaining electrically conductive layer by photolithography or the like. Then pressure is applied onto the exposed upper surface of the metal plate so as to form the recess on the upper surface and the projection on the mounting surface opposing thereto at the same time, and the light reflecting layer is formed similarly to Example 1. It is preferable to use the ordinary metal plate as described above, since it eliminates the need to align the through holes provided in the insulating member and the openings of the recesses when bonding the metallic mounting substrate and the insulating member with the insulating adhesive.

### EXAMPLE 4

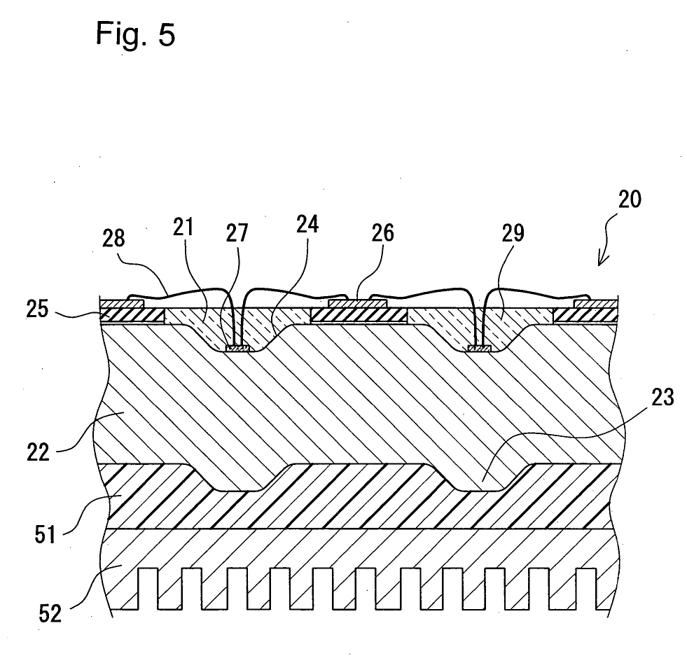

FIG. 5 shows the metallic mounting substrate of the present invention mounted on heat dissipating means 52 via heat transmitting means such as heat dissipating sheet 51. In the light emitting device 20 of this example shown in FIG. 5, the heat dissipating sheet 51 is put into close contact with the mounting surface of the metallic mounting substrate 22 that is provided with the projection 23, so as to fasten the heat dissipating means 52 such as heat sink provided with heat dissipating fin via the heat dissipating sheet 51.

The heat dissipating sheet 51 is obtained by, for example, mixing a matrix resin and a heat conductive filler and forming the mixture into a sheet. For the matrix resin, for example, silicone rubber is used and, for the heat conductive filler, particles, flakes or needle-like pieces of boron nitride is used. The heat dissipating sheet 51 is made by mixing the matrix resin (for example, silicone resin, silicone gel or silicone rubber) and the heat conductive filler (for example, alumina, magnesia or boron nitride) and forming the mixture into a sheet by means of rolls, calendar, extruding machine or the like similarly to ordinary rubber, with the sheet being pressed and vulcanized thereafter. Mix proportion of the matrix resin and the heat conductive filler is adjusted so as to achieve such softness and adhesiveness that allows the heat dissipating sheet 51 to firmly adhere to the mounting surface of the metallic mounting substrate 22 that has the projections 23.

As the metallic mounting substrate 22 is fastened onto the heat dissipating means 52 via the heat dissipating sheet 51 as in this example, contact area between the surface of the heat dissipating sheet 51 and the mounting surface of the metallic mounting substrate 22 that has the projections 23 becomes larger than in the case of the metallic mounting substrate of the prior art that is not provided with the projections. As a result, heat generated by the metallic substrate 22 is transmitted efficiently via the heat dissipating sheet 51 to the heat dissipating means 52 such as heat dissipating fin, thereby further improving the efficiency of heat dissipation.

1. A light emitting apparatus comprising:
a metallic substrate having at least one recess on the surface and at least one projection opposing the recess on the back surface thereof;
a light emitting element mounted in the recess of said metallic substrate, said light emitting element having a pair of positive and negative electrodes formed on one side thereof; and
electrically conductive members formed via an insulating member on the surface of said metallic substrate, said electrically conductive members being electrically connected with the pair of positive and negative electrodes of said light emitting element.

2. The light emitting apparatus according to claim 1, wherein said metallic substrate has a plurality of recesses and a plurality of projections.

3. The light emitting apparatus according to claim 1, wherein the inner wall of said recess is formed in the shape of mortar.

4. The light emitting apparatus according to claim 1, wherein a light reflecting layer is formed on the inner wall of said recess.

5. The light emitting apparatus according to claim 1, wherein the back surface of said metallic substrate is mounted on a heat dissipating m member via a heat transmitting member.

6. A method of manufacturing a light emitting apparatus comprising:
applying a pressure on the front surface of a metal plate so that a part of said metal plate protrudes on the back surface, thereby to form a recess and a projection on the front and back surfaces of said metal plate at the same time;
forming an electrically conductive member via an insulating member on the surface of said metal plate near the recess;
housing a light emitting element having a pair of positive and negative electrodes formed on the same side thereof in the recess of said metal plate; and
electrically connecting said electrically connecting members with the pair of positive and negative electrodes of said light emitting device.

7. The method of manufacturing a light emitting apparatus according to claim 6, wherein the pressure is applied to an exposed upper surface of said metal plate so as to form the recess and the projection, after forming said electrically conductive layer via said insulating layer on the upper surface of said metal plate and exposing a part of the upper surface of said metal plate from the side of said electrically conductive layer.

8. The method of manufacturing a light emitting apparatus according to claim 6, further comprising the step of forming a light reflecting layer on the inner wall of said recess after forming the recess and projection on said metal plate.
